(19) United States
(12) Patent Application Publication
(10) Pub. No.: US 2008/0140622 A1
(43) Pub. Date: Jun. 12, 2008

(54) Displaying Explain Data for a SQL Query of a Database

(76) Inventors: Robert J. Bestgen, Dodge Center, MN (US); Shantan Kethireddy, Rochester, MN (US); Michael D. Pfeifer, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/609,612

(22) Filed: Dec. 12, 2006

(51) Int. Cl. G06F 17/30

(52) U.S. Cl. 707/3; 707/E17.014

(57) ABSTRACT

Methods, apparatus, and products are disclosed for displaying explain data for a SQL query of a database that include: executing, by a SQL execution module, a SQL query in a database management system; accumulating, by the SQL execution module, actual run time data for the SQL query while executing the SQL query; and displaying, by an explain module, explain data for the SQL query while executing the SQL query, including displaying the accumulated actual run time data for the SQL query as part of the explain data for the SQL query.

### BACKGROUND OF THE INVENTION

1. Field of the Invention

The field of the invention is data processing, or, more specifically, methods, apparatus, and products for displaying explain data for a SQL query of a database.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a collection of related data and metadata. Metadata is data that describes other data such as, for example, data statistics. The data of a database is typically grouped into related structures called ‘tables,’ which in turn are organized in rows of individual data elements. The rows are often referred to a ‘records,’ and the individual data elements are referred to as ‘fields’ or ‘columns.’ In this specification generally, therefore, an aggregation of fields is referred to as a ‘record’ or a ‘data structure,’ and an aggregation of records is referred to as a ‘table.’

The metadata of a database typically includes schemas, table indexes, and database statistics. A schema is a structural description of the data in the database. A schema typically defines the columns of a table, the data types of the data contained in each column, which columns to include in an index, and so on. An index is a database structure used to optimize access to the rows in a table. An index is typically smaller than a table because an index is created using one or more columns of the table, and an index is optimized for quick searching, usually via a balanced tree. Database statistics describe the data in tables of a database. Database statistics may describe, for example, the number of records having a particular value for a particular field. As with the data of a database, metadata is often stored in tables of the database.

A computer system typically operates according to computer program instructions in computer programs. A computer program that supports access to information in a database is typically called a database management system or a ‘DBMS.’ A DBMS is computer software that is responsible for helping other computer programs access, manipulate, and save information in a database. A DBMS often utilizes metadata of the database for accessing and manipulating data of the database.

A DBMS typically supports access and management tools to aid users, developers, and other programs in accessing information in a database. One such tool is the structured query language (‘SQL’). A query is a request for information from a database. SQL is query language for requesting information from a database. Although there is a standard of the American National Standards Institute (‘ANSI’) for SQL, as a practical matter, most versions of SQL tend to include many extensions. For an example of a database query expressed in SQL, consider the following query:
select * from stores, transactions
where stores.location=“Rochester”
and stores.storeID=transactions.storeID

The exemplary SQL query above accesses information in a database by selecting records from two tables of the database, one table named ‘stores’ and another table named ‘transactions.’ The records selected are those having a value ‘Rochester’ in their store location fields and having transactions for the stores in Rochester. To retrieve the result for this SQL query, the DBMS generates a number of ‘primitive queries,’ each primitive query used to retrieve a portion of the data needed to satisfy the SQL query. In retrieving the data for this SQL query, a SQL engine will first retrieve records from the stores table and then use another primitive query to retrieve records from the transaction table. Records that satisfy the query requirements then are merged in a ‘join’ and returned as a result of the SQL query received by the DBMS. The sequence of the database operations mentioned above for carrying out the exemplary SQL query is the ‘access plan’ for the query.

In current DBMS environments, database management tools are often implemented with screens of a graphical user interface (‘GUI’). An example of such a DBMS tool is a query management tool that displays explain data for a query. Explain data is data describing an access plan for a query and database operations specified in the access plan for returning the results of a SQL query. Examples of explain data may include the database operations specified in the access plan to return the results of a query, the decision criteria used to choose particular database operations, estimated performance data for the specified database operations, and so on. An example of a DBMS tool that displays explain data includes the IBM Visual Explain database management tool, a database tool that graphically represents the implementation of a query. Such a tool provides a method of identifying and analyzing database performance problems by displaying an access plan for a query as a graph. Such a graph is a visual presentation of the database objects involved in a query such as, for example, tables and indexes. The graph also includes the database operations performed on those database objects such as, for example, scans and sorts, and depicts the flow of data from one node of the graph to another. In such manner, the resulting graph provides a visual explanation of the implementation of a query.

Such query management tools are typically used to pinpoint the location of a performance defect for a particular query. Before a user executes a query, the user starts a performance monitor that records the actual performance data for the query as part of the explain data as the query is executed. The explain data is then imported into a query management tool that visually depicts the access plan for the query along with the actual performance data for the various database operations described in the access plan. Such a design works well for explaining queries that may be executed in relatively short periods of time. However, this design does not work well in situations where the user submits queries for execution that may take hours or days to complete. In these situations, the user must wait for the execution of the query to end before the user can access the explain data containing the actual performance data. As such, readers will appreciate that room for improvement exists for displaying explain data for a SQL query of a database.

### SUMMARY OF THE INVENTION

Methods, apparatus, and products are disclosed for displaying explain data for a SQL query of a database that include: executing, by a SQL execution module, a SQL query in a database management system (‘DBMS’); accumulating, by the SQL execution module, actual run time data for the SQL query while executing the SQL query; and displaying, by an explain module, explain data for the SQL query while executing the SQL query, including displaying the accumulated actual run time data for the SQL query as part of the explain data for the SQL query.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for displaying explain data for a SQL query of a database according to embodiments of the present invention.

FIG. 2 sets forth a block diagram of automated computing machinery comprising an exemplary computer useful in displaying explain data for a SQL query of a database according to embodiments of the present invention.

FIG. 3 sets forth a flow chart illustrating an exemplary method for displaying explain data for a SQL query of a database according to embodiments of the present invention.

FIG. 4 sets forth a flow chart illustrating a further exemplary method for displaying explain data for a SQL query of a database according to embodiments of the present invention.

FIG. 5 sets forth a flow chart illustrating a further exemplary method for displaying explain data for a SQL query of a database according to embodiments of the present invention.

FIG. 6 sets forth an exemplary GUI display useful for displaying explain data for a SQL query of a database according to embodiments of the present invention.

FIG. 7 sets forth a further exemplary GUI display useful for displaying explain data for a SQL query of a database according to embodiments of the present invention.

### DETAILED DESCRIPTION OF EXEMPLARY EMBODIMENTS

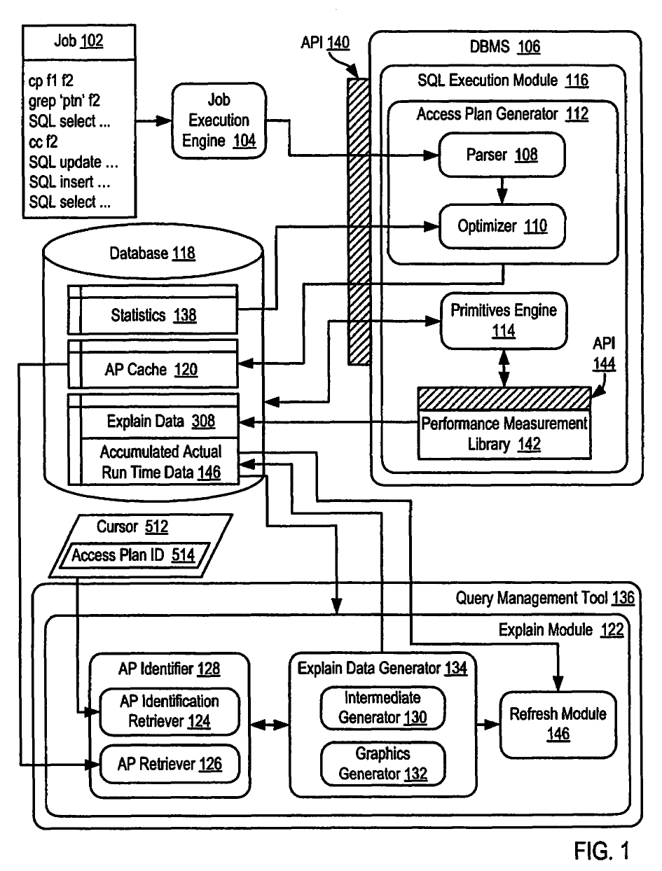

Exemplary methods, apparatus, and products for displaying explain data for a SQL query of a database in accordance with the present invention are described with reference to the accompanying drawings, beginning with FIG. 1. FIG. 1 sets forth a block diagram of an exemplary system for displaying explain data for a SQL query of a database according to embodiments of the present invention. The exemplary system of FIG. 1 operates to display explain data for a SQL query of a database according to embodiments of the present invention as follows: A SQL execution module (116) executes a SQL query in a database management system (‘DBMS’) (106). The SQL execution module (116) accumulates actual run time data for the SQL query while executing the SQL query. The explain module (122) displays explain data for the SQL query while executing the SQL query, including displaying the accumulated actual run time data for the SQL query as part of the explain data for the SQL query. A SQL query is computer program instructions for requesting information from a database. Explain data is data describing an access plan and database operations specified in the access plan for a SQL query.

In the exemplary system of FIG. 1, the DBMS (106) provides database management functions for database (118). As mentioned above, a database is a collection of related data and metadata. The other software components in the exemplary system of FIG. 1 access functions of the DBMS (106) using the application programming interface (‘API’) (140) exposed by the DBMS (106).

In the exemplary system of FIG. 1, the DBMS (106) receives a SQL query from a job execution engine (104). Job execution engine (104) is a software module that includes computer program instructions that process a job by passing commands from a job to software applications for processing the commands.

In the exemplary system of FIG. 1, the job execution engine (104) processes a job (102). Jobs may mingle SQL queries with other commands to perform various data processing tasks. The job (102), for example, includes several commands for execution as part of job (102), including:
cp f1 f2: an operating system command to copy one file to another file,
grep ‘ptn’ f2: a general regular expression command of the operating system to find occurrences of ‘ptn’ in file f2,
cc f2: a command to compile file f2 as a C program, and
several SQL commands, each of which passes as a parameter to an executable command named ‘SQL’ call parameters identifying a SQL query.

In this example, job execution engine (104) will pass the operating system commands from job (102) to the operating system for execution and pass the SQL queries from job (102) to DBMS (106) for execution. Job execution engine (104) passes the SQL queries to DBMS (106) through API (140). The ‘SQL’ command illustrated in job (102) is a function made available through API (140).

In the exemplary system of FIG. 1, the DBMS (106) includes a SQL execution module (116). The SQL execution module (116) is a software module that includes computer program instructions that execute a SQL query. Each SQL query is executed by implementing a sequence of database operations specified as an access plan. An access plan is a description of database functions for execution of a SQL query.

In the example of FIG. 1, the SQL execution module (116) includes an access plan generator (112). The access plan generator (112) is a software module that includes computer program instructions that create an access plan for the SQL query. For the following exemplary SQL query:
select * from stores, transactions
where stores.storeID=transactions.storeID,
   the access plan generator (112) may generate the following exemplary access plan:
tablescan stores
join to
index access of transactions

This exemplary access plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary access plan generator (112) of FIG. 1 includes a parser (108) and an optimizer (110) that are used to create the access plan for the SQL query. The parser (108) of FIG. 1 is implemented as computer program instructions that parse the SQL query. The SQL execution module (116) receives a SQL query in text form. Parser (108) retrieves the elements of the SQL query from the text form of the query and places the elements in a data structure more useful for data processing of the SQL query by the SQL execution module (116). The parser (108) then provides the elements of the parsed SQL query to the optimizer (110).

The exemplary optimizer (110) is implemented as a software module that includes computer program instructions that optimize the access plan in dependence upon the elements of the parsed SQL query and database statistics (138). Database statistics (138) may reveal, for example, that there are only two storeID values in the transactions table—so that it is an optimization, that is, more efficient, to scan the transactions table rather than using an index. Alternatively, database statistics (138) may reveal that there are many transaction records with only a few transactions records for each storeID—so that it is an optimization, that is, more efficient, to access the transactions records by an index. After the SQL query is parsed and the access plan is optimized the created access plan is stored for later use in the access plan cache (120) of database (118).

The exemplary SQL execution module (116) of FIG. 1 also includes a primitives engine (114). The primitives engine (114) is a software module that includes computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1,
retrieve one record from the transactions table into hash table H2,
join the results of the previous two operations, and
store the result of the join in table T1.

The exemplary primitives engine (114) of FIG. 1 also includes computer program instructions for starting and stopping the accumulation of actual run time data for a SQL query. Actual run time data is data that describes the actual performance of the database operations in the access plan for a SQL query, as opposed to estimated performance based on historical database statistics. The primitives engine (114) starts and stops the accumulation of actual run time data for a SQL query using functions of a performance measurement library (142).

The performance measurement library (142) of FIG. 1 is a software module such as, for example, a dynamically linked library available at run time, a statically linked library linked at compile time, a dynamically loaded Java class, or any other implementation as will occur to those of skill in the art that includes a set of computer program instructions for displaying explain data for a SQL query of a database according to embodiments of the present invention. The performance measurement library (142) operates generally for displaying explain data for a SQL query of a database according to embodiments of the present invention by accumulating actual run time data (146) for the SQL query while executing the SQL query. In addition, the performance measurement library (142) may also store the accumulated actual run time data (146) in the database (116) as part of the explain data (308) for use by the explain module (122). As the primitives engine (114) executes database operations specified in an access plan for a query, the primitives engine (114) calls functions in the performance measurement library (142) to measure the performance of each database operation. As the performance measurement library (142) measures the performance of each database operation, the performance measurement library (142) accumulates and stores the actual run time performance data for the database operations in the database (118). In the example of FIG. 1, the performance measurement library (142) exposes API (144) to allow the primitives engine (114) to access functions of the performance measurement library (142).

The exemplary system of FIG. 1 includes an explain module (122). The exemplary explain module (122) of FIG. 1 is a software component that includes computer program instructions for displaying explain data for a SQL query of a database according to embodiments of the present invention. The exemplary explain module (122) of FIG. 1 operates generally for displaying explain data for a SQL query of a database according to embodiments of the present invention by displaying explain data for the SQL query while executing the SQL query, including displaying the accumulated actual run time data for the SQL query as part of the explain data for the SQL query.

The explain module (122) of FIG. 1 includes an access plan identifier (128). The access plan identifier (128) is a software module that includes computer program instructions that identify an access plan associated with a particular query. The exemplary access plan identifier (128) of FIG. 1 includes an access plan identification retriever (124) and an access plan retriever (126). The access plan identification retriever (124) of FIG. 1 retrieves an access plan identification (514) from a cursor (512) of a job control block. A job control block is a data structure representing a job for a DBMS. The job control block is a useful place to store job-related data including, for example, cursors. A ‘cursor’ is a data structure whose data elements may include an access plan identification (514), and a description of the primitives of an access plan for a SQL query. The exemplary access plan identifier (128) of FIG. 1 also includes an access plan retriever (126), which is implemented in this example as computer program instructions that retrieve an access plan from an access plan cache (120) in dependence upon the access plan identification (514).

The exemplary explain module (122) of FIG. 1 also includes an explain data generator (134). The explain data generator (134) of FIG. 1 is a software module that includes computer program instructions that generate explain data in dependence upon an access plan. The exemplary explain data generator (134) of FIG. 1 includes an intermediate generator (130) implemented as computer program instructions that generate intermediate explain data for an access plan. Intermediate explain data is a non-visual encoding of an access plan for a SQL query for use in creating a visual representation, including indications of which icons to use in a graphic depiction of the plan, links among plan elements, and attributes of display elements including text attributes that represent values of accumulated actual run time data stored as part of explain data.

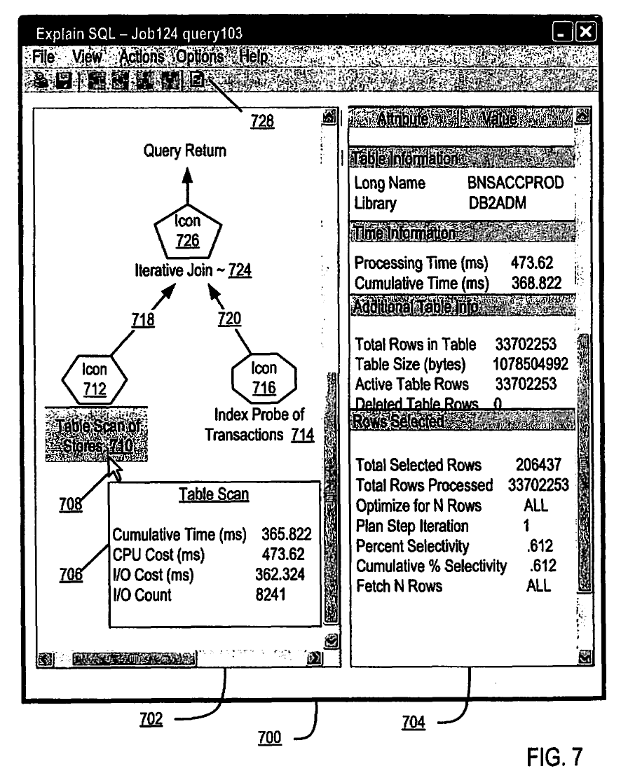

The exemplary explain data generator (134) of FIG. 1 also includes a graphics generator (132). The graphics generator (132) of FIG. 1 is a software component that includes computer program instructions for generating a graphic representation of the access plan in dependence upon intermediate explain data. A graphic representation of an access plan may include, for example, icons, visual connectors, or arrows that describe an access plan, and explanatory text for screen display. Graphic representations of access plans are explained in more detail below with reference to FIG. 7.

The exemplary explain module (122) of FIG. 1 also includes refresh module (146). The refresh module (146) is a software component that includes computer program instructions for refreshing a display of the accumulated actual run time data for a SQL query only with accumulated actual run time data having values that have changed during execution of the SQL query after a previous display of accumulated actual run time data. The refresh module (146) stores the values of previously displayed accumulated actual run time data (146) in computer memory. When refreshing the display, the refresh module (146) compares current values of accumulated actual run time data with previously stored values of accumulated actual run time data to determine those values of accumulated actual run time data that have changed during the execution of a SQL query after a previous display. In such a manner, the refresh module (146) advantageously displays accumulated actual run time data as the values of the run time data change.

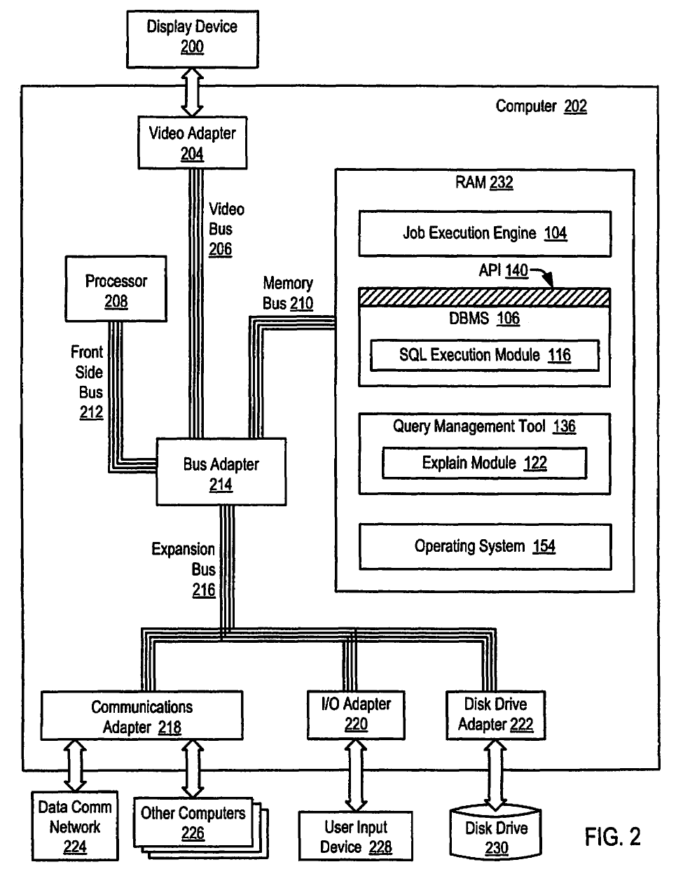

Displaying explain data for a SQL query of a database in accordance with the present invention in some embodiments may be implemented with one or more computers, that is, automated computer machinery. For further explanation, therefore, FIG. 2 sets forth a block diagram of automated computing machinery comprising an exemplary computer (202) useful in displaying explain data for a SQL query of a database according to embodiments of the present invention. The computer (202) of FIG. 2 includes at least one computer processor (208) or ‘CPU’ as well as random access memory (232) (‘RAM’) which is connected through a high speed memory bus (210) and bus adapter (214) to processor (208) and to other components of the computer (202).

Stored in RAM (232) are a job execution engine (104), DBMS (106) exposing API (140), and query management tool (136). The DBMS (106) of FIG. 2 includes a SQL execution module (116). The query management tool (136) of FIG. 2 includes an explain module (122). The job execution engine (104), the DBMS (106), the SQL execution module (116), the query management tool (136), and the explain module (122) illustrated in FIG. 2 are software components, that is computer program instructions, that operate as described above with reference to FIG. 1.

Also stored in RAM (232) is an operating system (154). Operating systems useful in computers according to embodiments of the present invention include UNIX™, Linux™, Microsoft NT™, IBM's AIX™, IBM's i5/OS™, and others as will occur to those of skill in the art. The operating system (154), the job execution engine (104), the DBMS (106), the SQL execution module (116), the query management tool (136), and the explain module (122) in the example of FIG. 2 are shown in RAM (232), but many components of such software typically are stored in non-volatile memory also, for example, on a disk drive (230).

The exemplary computer (202) of FIG. 2 includes bus adapter (214), a computer hardware component that contains drive electronics for high speed buses, the front side bus (212), the video bus (206), and the memory bus (210), as well as drive electronics for the slower expansion bus (216). Examples of bus adapters useful in computers useful according to embodiments of the present invention include the Intel Northbridge, the Intel Memory Controller Hub, the Intel Southbridge, and the Intel I/O Controller Hub. Examples of expansion buses useful in computers useful according to embodiments of the present invention may include Peripheral Component Interconnect (‘PCI’) buses and PCI Express (‘PCIe’) buses.

The exemplary computer (202) of FIG. 2 also includes disk drive adapter (222) coupled through expansion bus (216) and bus adapter (214) to processor (208) and other components of the exemplary computer (202). Disk drive adapter (222) connects non-volatile data storage to the exemplary computer (202) in the form of disk drive (230). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art. The exemplary computer (202) of FIG. 2 includes one or more input/output (‘I/O’) adapters (220). I/O adapters in computers implement user-oriented input/output through, for example, software drivers and computer hardware for controlling output to display devices such as computer display screens, as well as user input from user input devices (228) such as keyboards and mice. The exemplary computer (202) of FIG. 2 includes a video adapter (204), which is an example of an I/O adapter specially designed for graphic output to a display device (200) such as a display screen or computer monitor. Video adapter (204) is connected to processor (208) through a high speed video bus (206), bus adapter (214), and the front side bus (212), which is also a high speed bus.

The exemplary computer (202) of FIG. 2 includes a communications adapter (218) for data communications with other computers (226) and for data communications with a data communications network (224). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for displaying explain data for a SQL query of a database according to embodiments of the present invention include modems for wired dial-up communications, IEEE 802.3 Ethernet adapters for wired data communications network communications, and IEEE 802.11b adapters for wireless data communications network communications.

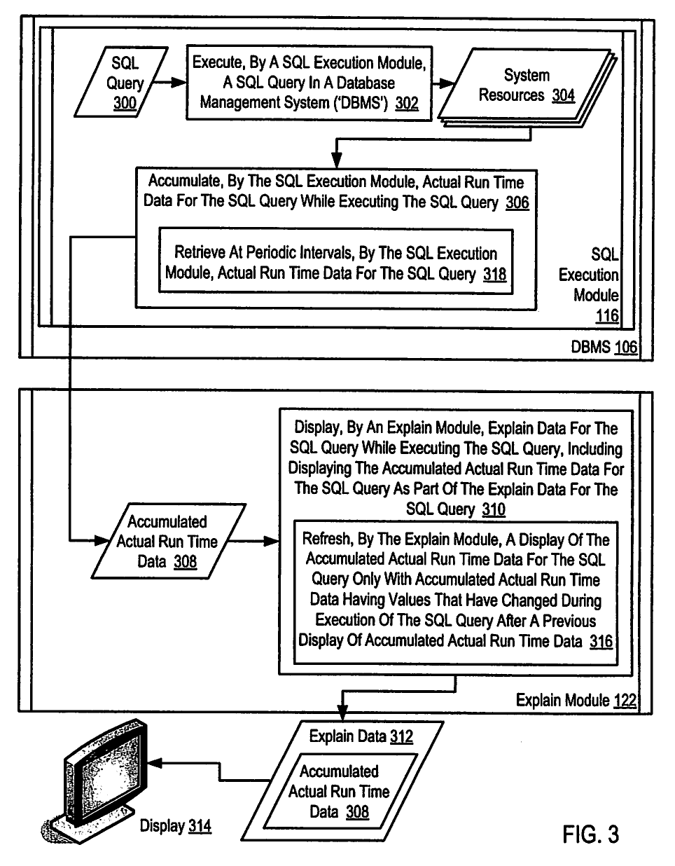

For further explanation, FIG. 3 sets forth a flow chart illustrating an exemplary method for displaying explain data for a SQL query of a database according to embodiments of the present invention. The method of FIG. 3 includes executing (302), by a SQL execution module (116), a SQL query (300) in a database management system (‘DBMS’) (106). The SQL query (300) of FIG. 3 represents a request for information from a database.

In the method of FIG. 3, a SQL execution module (116) may execute (302) a SQL query (300) in a database management system (‘DBMS’) (106) by generating an access plan in dependence upon the SQL query (300) and performing database operations according to the generated access plan. The SQL execution module (116) may generate an access plan by parsing the SQL query into primitives, and optimizing an access plan in dependence upon database statistics. Database statistics may reveal that it is more efficient to scan a particular table in a database rather than using an index. Alternatively, database statistics may reveal that that it is more efficient to access particular records by an index. In such manner, the SQL execution module (116) may optimize an access plan for executing a SQL query. While executing (302) the SQL query (300), the SQL execution module (116) uses system resources such as, for example, processor resources, input/output (‘I/O’) resources, memory resources, network resources, and other resources as will be apparent to those skilled in the art. System resources (304) of FIG. 3 represent the system resources utilized by the SQL execution module (116) during the execution of the SQL query (300).

The method of FIG. 3 also includes accumulating (306), by the SQL execution module (116), actual run time data (308) for the SQL query (300) while executing the SQL query (300). The accumulated actual run time data (308) represents system resources used to perform one or more database operations in the access plan for a SQL query (300). The accumulated actual run time data (308) is so termed because the actual run time data for a query is accumulated as the individual database operations are executed. Accumulating (306), by the SQL execution module (116), actual run time data (308) for the SQL query (300) while executing the SQL query (300) according to the method of FIG. 3 includes retrieving (318) at periodic intervals, by the SQL execution module (116), actual run time data (308) for the SQL query (300). The SQL execution module (116) may retrieve (318) actual run time data (308) for the SQL query (300) at periodic intervals according to the method of FIG. 3 by calculating the actual run time data from the changes in the system resources (304) over an interval of time and updating the accumulated actual run time data (308) in the explain data (312) with the calculated actual run time data for the interval. That is, the SQL execution module (116) updates the accumulated actual run time data (308) in the explain data (312) with the system resources utilized during execution of the SQL query (300) while the SQL execution module (116) performs databases operations specified in an access plan for the SQL query (300).

Consider as an example for further explanation of accumulating actual run time data a SQL execution module that calculates that the first database operation specified in an access plan consumed 300 milliseconds of processor time during the performance of the first database operation. The SQL execution module may then update the accumulated actual run time data in the explain data to reflect that performing the first database operation consumed 300 millisecond. After execution of the second database operation specified in the access plan for the query, the SQL execution module may calculate that the second database operation consumed 450 milliseconds of processor time during the performance of the second database operation. The SQL execution module may then update the accumulated actual run time data in the explain data to reflect that performing the second database operation consumed 450 millisecond or that the total execution of the query has consumed 750 milliseconds. After execution of the third database operation specified in the access plan for the query, the SQL execution module may calculate that the third database operation consumed 250 milliseconds of processor time during the performance of the third database operation. The SQL execution module may then update the accumulated actual run time data in the explain data to reflect that performing the third database operation consumed 250 millisecond or that the total execution of the query has consumed 1000 milliseconds. In the example above, actual run time data is implemented as processor execution time. Readers will note, however, that implementing actual run time data as processor execution time is for explanation only and not for limitation. In fact, other implementations of actual run time data as will occur to those of skill in the art may also be useful according to embodiments of the present invention such as, for example, memory usage, input/output resource usage, network usage, rows traversed, row selectivity, and so on.

The method of FIG. 3 includes displaying (310), by an explain module (122), explain data (312) for the SQL query (300) while executing the SQL query, including displaying the accumulated actual run time data (308) for the SQL query (300) as part of the explain data (312) for the SQL query (300). The explain data (312) of FIG. 3 represents data describing an access plan and database operations specified in the access plan for a SQL query. The explain module (122) may display (310) explain data (312) for the SQL query (300) according to the method of FIG. 3 by retrieving the explain data (312) for an access plan of the SQL query (300) and rendering the explain data (312) on a display (314) using a GUI as discussed in more detail below with reference to FIG. 7. The explain module (122) may display the accumulated actual run time data (308) for the SQL query (300) as part of the explain data (312) for the SQL query (300) according to the method of FIG. 3 by retrieving the accumulated actual run time data (308) for the individual database operations described in the explain data (312) and rendering the accumulated actual run time data (308) on a display (314) using a GUI as discussed in more detail below with reference to FIG. 7.

In the method of FIG. 3, displaying (310), by an explain module (122), explain data (312) for the SQL query (300) while executing (302) the SQL query (300) includes refreshing (316), by the explain module (122), a display (314) of the accumulated actual run time data (308) for the SQL query (300) only with accumulated actual run time data (308) having values that have changed during execution (302) of the SQL query (300) after a previous display of accumulated actual run time data (308). The explain module (122) may refresh (316) a display (314) of the accumulated actual run time data (308) for the SQL query (300) according to the method of FIG. 3 by storing the previous accumulated actual run time data rendered on the display (314) in computer memory, determining whether the current accumulated actual run time data matches the previous accumulated actual run time data, and rendering the current accumulated actual run time data on the display (314) if the current accumulated actual run time data does not match the previous accumulated actual run time data. Consider, for example, that an explain module has previously displayed that the current SQL query has utilized 320 millisecond of processor time and has utilized twenty percent of the available computer memory after executing the first database operation specified in an access plan for the query. After such a previous display, the explain module determines that the SQL query has now utilized 600 millisecond of processor time but has still only utilized twenty percent of the available computer memory. In such an example, the explain module refreshes the display of the accumulated actual run time data to only reflect the change from utilizing 320 millisecond of processor time to utilizing 600 millisecond of processor time.

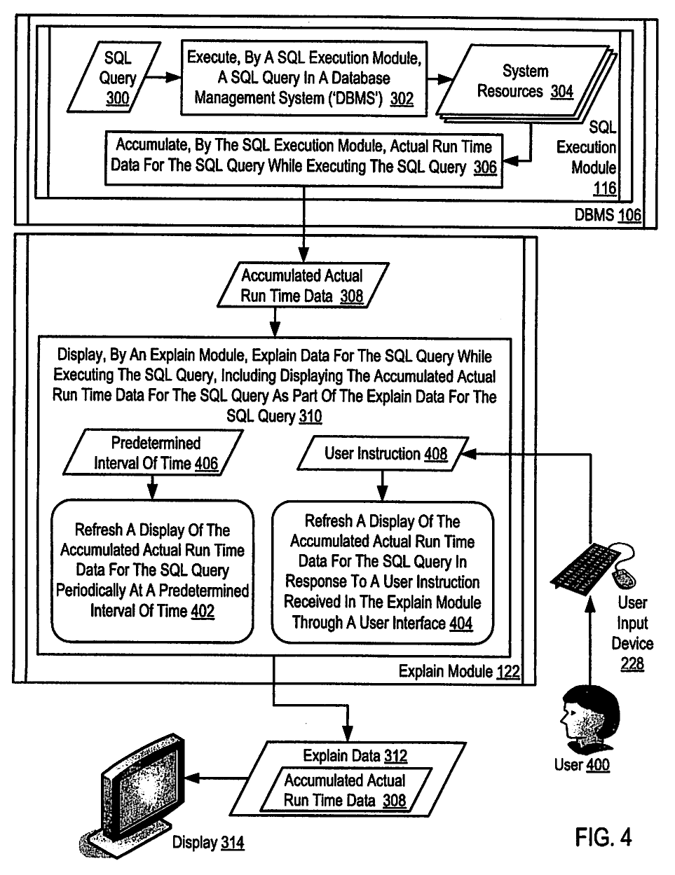

When the explain module displays explain data for the SQL query while executing the SQL query, the explain module may refresh a display of the accumulated actual run time data for the SQL query in response to a user instruction or periodically at a predetermined interval of time. For further explanation, therefore, FIG. 4 sets forth a flow chart illustrating a further exemplary method for displaying explain data for a SQL query of a database according to embodiments of the present invention that includes refreshing (404) a display (314) of the accumulated actual run time data (308) for the SQL query (300) in response to a user instruction (408) received in the explain module (122) through a user interface and refreshing (402) a display (314) of the accumulated actual run time data (308) for the SQL query (300) periodically at a predetermined interval of time (406).

The method of FIG. 4 is similar to the method of FIG. 3. That is, the method of FIG. 4 includes executing (302), by a SQL execution module (116), a SQL query (300) in a database management system (‘DBMS’) (106), accumulating (306), by the SQL execution module (116), actual run time data (304) for the SQL query (300) while executing the SQL query (300), and displaying (310), by an explain module (122), explain data (312) for the SQL query (300) while executing the SQL query, including displaying the accumulated actual run time data (308) for the SQL query (300) as part of the explain data (312) for the SQL query (300). The example of FIG. 4 is also similar to the example of FIG. 3 in that the example of FIG. 4 includes system resources (304) and a display (314) on which the accumulated actual run time data (308) is rendered.

In the example of FIG. 4, displaying (310), by an explain module (122), explain data (312) for the SQL query (300) while executing the SQL query includes refreshing (404) a display (314) of the accumulated actual run time data (308) for the SQL query (300) in response to a user instruction (408) received in the explain module (122) through a user interface. The explain module (122) may refresh (404) a display (314) of the accumulated actual run time data (308) for the SQL query (300) in response to a user instruction (408) according to the method of FIG. 4 by receiving a user instruction (408), retrieving the current accumulated actual run time data (308) in response to the received user instruction (408), and rendering the current accumulated actual run time data (308) on the display (314).

In the example of FIG. 4, user (400) provides the user instruction (408) through a user interface implemented in FIG. 4 as user input device (228). Although FIG. 4 depicts the user input device as a mouse and a keyboard, other user interfaces may be useful for displaying explain data for a SQL query of a database according to embodiments of the present invention such as, for example, microphones, electronic writing slates, touch pads, or any other user interfaces as will occur to those of skill in the art.

In the example of FIG. 4, displaying (310), by an explain module (122), explain data (312) for the SQL query (300) while executing the SQL query also includes refreshing (402) a display (314) of the accumulated actual run time data (308) for the SQL query (300) periodically at a predetermined interval of time (406). The explain module (122) may refresh (402) a display (314) of the accumulated actual run time data (308) for the SQL query (300) periodically at a predetermined interval of time (406) according to the method of FIG. 4 by determining whether the predetermined interval of time (406) has elapsed, retrieving the current accumulated actual run time data (308) if the predetermined interval of time (406) has elapsed, and rendering the accumulated actual run time data (308) on a display (314). Consider, for example, a predetermined interval of time that is set by a user as 1 second. In such an example, the explain module refreshes a display with the actual run time data every second as the actual run time data is accumulated during the execution of the SQL query.

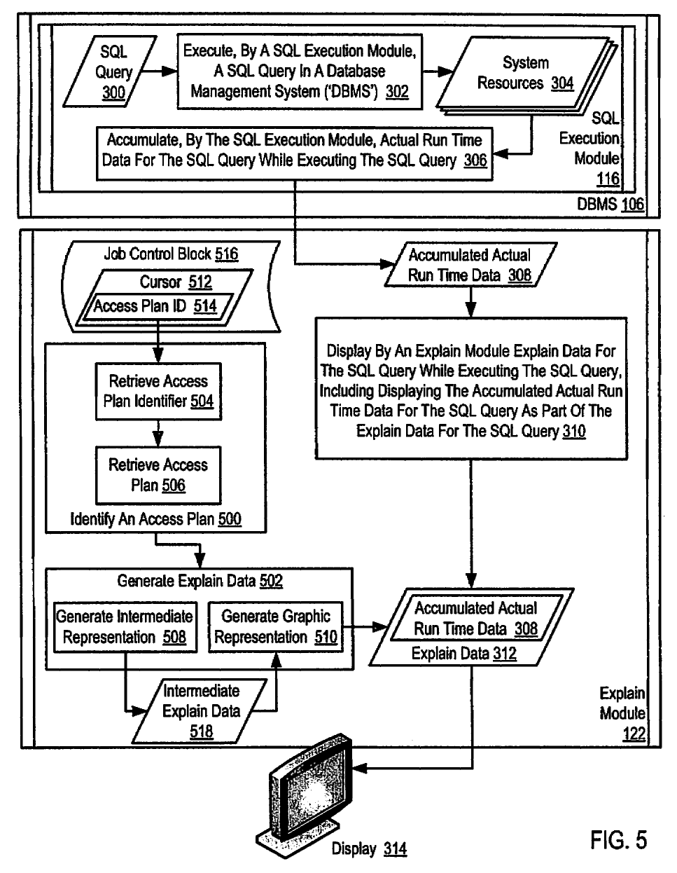

As mentioned above, the explain module displays explain data for a SQL query while executing the query. In addition to displaying the explain data, the explain module may also generate the explain data that is displayed. For further explanation, therefore, FIG. 5 sets forth a flow chart illustrating a further exemplary method for displaying explain data for a SQL query of a database according to embodiments of the present invention that includes generating (502), by the explain module (122), explain data (312) for the execution of the SQL query (300) in dependence upon the access plan (522).

The method of FIG. 5 is similar to the method of FIG. 3. That is, the method of FIG. 5 includes executing (302), by a SQL execution module (116), a SQL query (300) in a database management system (‘DBMS’) (106), accumulating (306), by the SQL execution module (116), actual run time data (304) for the SQL query (300) while executing the SQL query (300), and displaying (310), by an explain module (122), explain data (312) for the SQL query (300) while executing the SQL query, including displaying the accumulated actual run time data (308) for the SQL query (300) as part of the explain data (312) for the SQL query (300). The example of FIG. 5 is also similar to the example of FIG. 3 in that the example of FIG. 5 includes system resources (304) and a display (314) on which the accumulated actual run time data (308) is rendered.

The method of FIG. 5 also includes identifying (500), by the explain module (122), an access plan (522) associated with the SQL query (300). Identifying (500), by the explain module (122), an access plan (522) associated with the SQL query (300) according to the method of FIG. 5 is carried out by retrieving (504) an access plan identification (514) from a cursor (512) of a job control block (516) and retrieving (506) an access plan from an access plan cache in dependence upon the access plan identification (514). As mentioned above, a job control block (516) is a data structure representing a job for a DBMS. A job control block is a useful place to store job-related data including, for example, access plan identification codes and cursors. A cursor (512) is a data structure whose data elements describe or identify the primitives of an access plan for a SQL query.

The method of FIG. 5 also includes generating (502), by the explain module (122), explain data (312) for the execution of the SQL query (300) in dependence upon the access plan. Generating (502), by the explain module (122), explain data (312) for the execution of the SQL query (300) in dependence upon the access plan according to the method of FIG. 5 is carried out by generating (508) intermediate explain data (518) of the access plan and generating (510) a graphical representation for an access plan in dependence upon the intermediate explain data (518). As mentioned above, intermediate explain data is a non-visual encoding of an access plan for a SQL query for use in creating a visual representation, including indications of which icons to use in a graphic depiction of the plan, links among plan elements, and attributes of display elements including text attributes that represent values of accumulated actual run time data stored as part of explain data. Graphic representation of the access plan includes icons, connectors or arrows indicating access path, and explanatory text for screen display. In the example of FIG. 5, the explain module also displays accumulated actual run time data (308) as part of the graphic representation of the access plan.

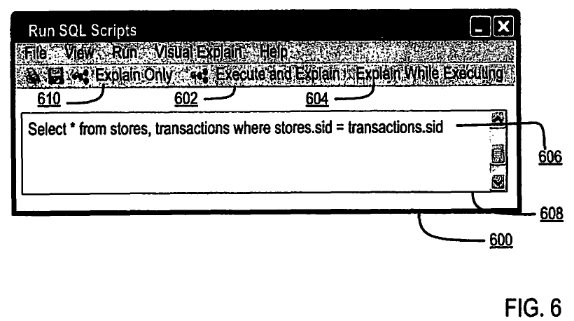

For further explanation, FIG. 6 sets forth an exemplary GUI display (600) useful for displaying explain data for a SQL query of a database according to embodiments of the present invention. The exemplary GUI display (600) of FIG. 6 may be utilized by a SQL query management tool such as, for example, the query management tool discussed above with reference to FIG. 1. The exemplary GUI display (600) of FIG. 6 includes a text box (608) in which the text form of a SQL query may be entered by a user through a user input device such as, for example, a keyboard or microphone, for execution of the SQL query. In the example of FIG. 6, the following exemplary SQL query (606) is depicted in the text box (608):
select * from stores, transactions
where stores.storeID=transactions.storeID.

The exemplary GUI display (600) of FIG. 6 includes GUI toolbar buttons (610, 602, 604) for explaining a query, executing and explaining a query, and explaining a query while executing. The exemplary toolbar button ‘Explain Only’ (610), when invoked, causes explain data for the SQL query that a user inputs into the text box (608) to be displayed without executing the SQL query. The exemplary toolbar button ‘Execute and Explain’ (602), when invoked, causes explain data for the SQL query input into the text box (608) to be displayed while initiating the execution of the SQL query. The exemplary toolbar button ‘Explain While Executing’ (604), when invoked, causes explain data for the SQL query input into the text box (608) to be displayed while executing the query and refreshed during the execution of the SQL query at a predetermined time interval set by a user as discussed above. In this example, invoking a particular GUI toolbar button (610, 602, 604) initially generates the display illustrated in the exemplary GUI display of FIG. 7.

FIG. 7 sets forth a further exemplary GUI display (700) useful for displaying explain data for a SQL query of a database according to embodiments of the present invention. The GUI display (700) is used by an explain module to display graphic explain data for a SQL query, including accumulated actual run time data for the SQL query. Each SQL query is carried out by a sequence of database operations specified as an access plan. Explain data is data describing an access plan and database operations specified in the access plan for a SQL query. The example of FIG. 7 illustrates an access plan for a SQL query as a tree structure implemented with graphic explain data (702). In particular, the example of FIG. 7 illustrates graphic explain data for the SQL query (606) illustrated in FIG. 6. The graphic explain data illustrated in FIG. 7 is derived from an access plan generated to support execution of the pertinent SQL query. The exemplary access plan from which the graphic explain data of FIG. 7 is derived is as follows:
tablescan stores
join to
index access of transactions

In the example of FIG. 7, icon (712) is graphic explain data representing the scan of the stores table from the first line of the access plan. The display text (710) is additional explain data representing the tablescan of stores. The display area for the tablescan is selected by use of mouse pointer (708). All information in text box (704) is explain data for the tablescan of stores displayed in response to the selection of the display area for the tablescan of stores. The information displayed in the text box (704) also includes accumulated actual runtime data that is updated at a periodic time interval during the execution of the tablescan operation. While the mouse pointer is over the display area for the tablescan, additional explain data in the form of tooltip text (706) is displayed for the tablescan of stores. The information displayed in the tooltip text (706) also includes accumulated actual runtime data that is updated at a periodic time interval during the execution of the tablescan operation. The particular information displayed as tooltip text or explain text in text box (704) is for explanation only, not for limitation of the invention. The display of any explain text as will occur to those of skill in the art is well within the scope of the present invention.

Icon (716) is graphic explain data representing the index access of the transactions table from the third line of the access plan. The display text (714) is additional explain data representing the index access of the transactions table. Icon (726) is graphic explain data representing the join of the results of the scan of the stores table from the first line of the access plan and the index access of the transactions table from the third line of the access plan. The display text (724) is additional explain data representing the join from the second line of the access plan. The arrows (718, 720) are graphic explain data representing the links among elements in the illustrated access path, forming a tree structure as mentioned above.

The graphic explain data illustrated in FIG. 7 may be generated in dependence upon intermediate explain data. Graphic representation of the access plan, as shown in FIG. 7, includes icons, connectors, or arrows indicating access path, and explanatory text for screen display. Intermediate explain data is a non-visual encoding of an access path for a SQL query for use in creating a visual representation, including indications of which icons to use in a graphic depiction of the path, links among path elements, and attributes of display elements. Icons and other graphic elements are relatively heavy weight in terms of computer resource utilization. Intermediate explain data advantageously provides a way to move explain data among functional modules of a system in compact form.

Although a user may set an explain module to periodically refresh the display of explain data and the accumulated actual run time data for the database operations, the exemplary GUI display (700) of FIG. 7 also includes a GUI toolbar button (728) for refreshing the GUI display manually. In this example, the GUI toolbar button (728) for refreshing the GUI display, when invoked, causes the refresh of the display of the accumulated actual run time data for the SQL query only with accumulated actual run time data having values that have changed during execution of the SQL query after a previous display of accumulated actual run time data. Consider, for example, that the current “Processing Time (ms)” spent on the tablescan database operation is 600 milliseconds, not 473.62 milliseconds as presently displayed in the exemplary GUI display (700). Invoking the refresh button (728) causes the text box (704) to display 600 as the “Processing Time (ms)” instead of 473.62. In such an example, the display of accumulated actual run time data for each database operation of the access plan may be refreshed. In the example above, actual run time data is implemented as processor execution time. Readers will note, however, that implementing actual run time data as processor execution time is for explanation only and not for limitation. In fact, other implementations of actual run time data as will occur to those of skill in the art may also be useful according to embodiments of the present invention such as, for example, memory usage, input/output resource usage, network usage, rows traversed, row selectivity, and so on.

Exemplary embodiments of the present invention are described largely in the context of a fully functional computer system for displaying explain data for a SQL query of a database. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of displaying explain data for a Structured Query Language (‘SQL’) query of a database, the method comprising:
executing, by a SQL execution module, a SQL query in a database management system (‘DBMS’);
accumulating, by the SQL execution module, actual run time data for the SQL query while executing the SQL query; and
displaying, by an explain module, explain data for the SQL query while executing the SQL query, including displaying the accumulated actual run time data for the SQL query as part of the explain data for the SQL query.

2. The method of claim 1 wherein displaying the accumulated actual run time data for the SQL query as part of the explain data for the SQL query further comprises refreshing, by the explain module, a display of the accumulated actual run time data for the SQL query only with accumulated actual run time data having values that have changed during execution of the SQL query after a previous display of accumulated actual run time data.

3. The method of claim 1 wherein accumulating, by the SQL execution module, actual run time data for the SQL query while executing the SQL query further comprises retrieving at periodic intervals, by the SQL execution module, actual run time data for the SQL query.

4. The method of claim 1 wherein displaying, by an explain module, explain data for the SQL query while executing the SQL query further comprises refreshing a display of the accumulated actual run time data for the SQL query in response to a user instruction received in the explain module through a user interface.

5. The method of claim 1 wherein displaying, by an explain module, explain data for the SQL query while executing the SQL query further comprises refreshing a display of the accumulated actual run time data for the SQL query periodically at a predetermined interval of time.

6. The method of claim 1 further comprising:
identifying, by the explain module, an access plan associated with the SQL query; and
generating, by the explain module, explain data for the execution of the SQL query in dependence upon the access plan.

7. Apparatus for displaying explain data for a Structured Query Language (‘SQL’) query of a database, the apparatus comprising a computer processor, a computer memory operatively coupled to the computer processor, the computer memory having disposed within it computer program instructions capable of:
executing, by a SQL execution module, a SQL query in a database management system (‘DBMS’);
accumulating, by the SQL execution module, actual run time data for the SQL query while executing the SQL query; and
displaying, by an explain module, explain data for the SQL query while executing the SQL query, including displaying the accumulated actual run time data for the SQL query as part of the explain data for the SQL query.

8. The apparatus of claim 7 wherein displaying the accumulated actual run time data for the SQL query as part of the explain data for the SQL query further comprises refreshing, by the explain module, a display of the accumulated actual run time data for the SQL query only with accumulated actual run time data having values that have changed during execution of the SQL query after a previous display of accumulated actual run time data.

9. The apparatus of claim 7 wherein accumulating, by the SQL execution module, actual run time data for the SQL query while executing the SQL query further comprises retrieving at periodic intervals, by the SQL execution module, actual run time data for the SQL query.

10. The apparatus of claim 7 wherein displaying, by an explain module, explain data for the SQL query while executing the SQL query further comprises refreshing a display of the accumulated actual run time data for the SQL query in response to a user instruction received in the explain module through a user interface.

11. The apparatus of claim 7 wherein displaying, by an explain module, explain data for the SQL query while executing the SQL query further comprises refreshing a display of the accumulated actual run time data for the SQL query periodically at a predetermined interval of time.

12. The apparatus of claim 7 further comprising computer program instructions capable of:
identifying, by the explain module, an access plan associated with the SQL query; and
generating, by the explain module, explain data for the execution of the SQL query in dependence upon the access plan.

13. A computer program product for displaying explain data for a Structured Query Language (‘SQL’) query of a database, the computer program product disposed in a signal bearing medium, the computer program product comprising computer program instructions capable of:
executing, by a SQL execution module, a SQL query in a database management system (‘DBMS’);
accumulating, by the SQL execution module, actual run time data for the SQL query while executing the SQL query; and
displaying, by an explain module, explain data for the SQL query while executing the SQL query, including displaying the accumulated actual run time data for the SQL query as part of the explain data for the SQL query.

14. The computer program product of claim 13 wherein the signal bearing medium comprises a recordable medium.

15. The computer program product of claim 13 wherein the signal bearing medium comprises a transmission medium.

16. The computer program product of claim 13 wherein displaying the accumulated actual run time data for the SQL query as part of the explain data for the SQL query further comprises refreshing, by the explain module, a display of the accumulated actual run time data for the SQL query only with accumulated actual run time data having values that have changed during execution of the SQL query after a previous display of accumulated actual run time data.

17. The computer program product of claim 13 wherein accumulating, by the SQL execution module, actual run time data for the SQL query while executing the SQL query further comprises retrieving at periodic intervals, by the SQL execution module, actual run time data for the SQL query.

18. The computer program product of claim 13 wherein displaying, by an explain module, explain data for the SQL query while executing the SQL query further comprises refreshing a display of the accumulated actual run time data for the SQL query in response to a user instruction received in the explain module through a user interface.

19. The computer program product of claim 13 wherein displaying, by an explain module, explain data for the SQL query while executing the SQL query further comprises refreshing a display of the accumulated actual run time data for the SQL query periodically at a predetermined interval of time.

20. The computer program product of claim 13 further comprising computer program instructions capable of:
identifying, by the explain module, an access plan associated with the SQL query; and
generating, by the explain module, explain data for the execution of the SQL query in dependence upon the access plan.
